(19) United States
(12) Patent Application Publication
(10) Pub. No.: US 2017/0120739 A1
(43) Pub. Date: May 4, 2017

(54) UTILITY VEHICLE, IN PARTICULAR MOTOR TRUCK, HAVING AT LEAST ONE DOUBLE-AXLE UNIT

(71) Applicant: MAN Truck & Bus AG, Munchen (DE)

(72) Inventors: Philipp Wagner, Friedberg (DE); Jan Fleischhacker, Olching (DE); Philipp Beierer, Unterschleissheim (DE); Michael Peter, Wasserburg (DE); Franz-Georg Resch, Turkenfeld (DE)

(21) Appl. No.: 15/343,826

(22) Filed: Nov. 4, 2016

(30) Foreign Application Priority Data
Nov. 4, 2015 (DE) 102015014213.5

(51) Int. Cl. B60K 6/12; B60K 17/16; B60K 7/00; B60K 6/52; F16H 48/08; B60K 17/36; B60K 6/48

(52) U.S. Cl. CPC B60K 6/12; B60K 17/36; B60K 17/16; B60K 6/48; B60K 6/52; F16H 48/08; B60K 7/0015; B60K 2006/123; B60Y 2200/92; Y10S 903/902

(57) ABSTRACT

A utility vehicle, in particular a motor truck or motor bus, is provided having at least one double-axle unit. The double-axle unit has a driven first axle and a driven second axle, wherein the first axle can be driven by way of a mechanical drivetrain and the second driven axle can be driven by at least one hydraulic motor of a hydrostatic drive.

### FILED OF THE DISCLOSURE

The present disclosure relates to a utility vehicle, in particular a motor truck or motor bus, having at least one double-axle unit.

### BACKGROUND

From the prior art, utility vehicles, in particular motor trucks, are known which have a double-axle unit with two driven axles. A double-axle unit is also referred to as a so-called Tandem axle. In the case of a double-axle unit, the axle spacing is generally less than 2 metres, see for example Nutzfahrzeugtechnik: Grundlagen, Systeme, Komponenten [Utility vehicle technology: principles, systems, components], ISBN 978-3-8348-1795-2, Stefan Breuer (Ed.), Springer Vieweg, 2012. Equalization of axle load between the two driven axles may be realized either by way of a pivotable central bearing, that is to say the axles are connected to one another by way of a rocker or are pivotable relative to one another by way of a central bearing. These embodiments are known as so-called leaf-spring-mounted double-axle units. Air-spring-mounted double-axle units are however also known, in which the vehicle ride-height regulation is controlled by way of travel sensors, that is to say the articulation of the two axles of the double-axle unit with respect to one another is adjusted by way of the air pressure. The wheels of a double-axle unit are generally similar, that is to say are all of either single-tire or double-tire configuration and non-steerable.

FIG. 1 shows a simplified illustration of a conventional double-axle unit having two driven axles 9, 10, wherein the attachment of the axles to a supporting frame of the vehicle, for example by way of a leaf spring arrangement, is not illustrated. The front axle 9 of the double-axle unit as viewed in the direction of travel of the vehicle is driven by way of a drive shaft 2 which is arranged between the internal combustion engine/gearbox unit of the vehicle and the double-axle unit. A drive bevel gear arranged on the drive shaft is in this case in engagement with a crown gear of an axle differential 13 of the front axle 9 of the double-axle unit.

For the drive of the second axle 10 of the double-axle unit, a drive-through axle or an articulated shaft 11 is provided between the two axles 9, 10 of the double-axle unit.

Also known from the prior art are utility vehicles which have at least two hydraulic wheel motors for the drive of at least two wheels. The at least two wheel motors are integrated into a closed hydrostatic circuit. It is thus possible to realize considerable weight and efficiency advantages in relation to vehicles with permanent all-wheel drive, in particular in vehicles in which the all-wheel drive is required only for a small part of the actual driving route.

FIG. 2 is a schematic illustration of such a drive system known from the prior art, such as is known for example from the document EP 1 886 861 A2. The drive system comprises a conventional rear axle 9 which is driven mechanically by way of a drive shaft 2, wherein the drive shaft 2 is operatively connected to an axle differential 13 of the rear axle 9. The drive system furthermore comprises at least two front wheels 1 which can be driven by way of hydraulic wheel motors RM and which are arranged in steerable fashion on a front axle 3. The two wheel motors RM are integrated into a closed hydrostatic circuit. Here, a main pump 5 is driven mechanically by way of the drivetrain 4 of the vehicle. The two wheel motors RM can be activated by way of a control valve 7. Furthermore, a feed pump 6 may be provided for the purposes of compensating internal and external leakage quantities that arise. A pressurized-oil distributor 8 which acts as a hydraulic transverse differential and which is regulated by way of a control block may be arranged in the hydraulic circuit for the front wheels 1, which pressurized-oil distributor has the effect of splitting the oil supply of the wheel motors RM into oil flows Q1 and Q2 which are expediently of equal magnitude. In this way, a hydraulically acting transverse lock is realized. EP 2 559 581 A1 has disclosed a drive system with a hydrostatic auxiliary drive which differs from that described in FIG. 2 substantially in that, instead of the pressurized-oil distributor 8 which acts as a hydraulic transverse differential, a brake system is designed so as to act as a locking differential for the front wheels 1. The laid-open specification US 2015/0247404 A1 has disclosed a hydraulic device, for example for use as a hydraulic motor of a hydrostatic drive for the drive of a vehicle axle. In particular, the structural implementation of the activation of a hydraulic motor at the level of the wheel motor itself is described. The hydrostatic wheel drive with deployable piston is composed of a hub (fixed), a wheel (movable) and a drive device (radial piston motor with deployable piston). Here, the drive device is designed so as to be fixedly connected to the hub or wheel and such that it can, by way of the deployable piston, exert a torque on the respective other partner. In particular, it is proposed that the fixed connection to the wheel or hub be eliminated for example by way of a clutch, that is to say the drive device can rotate freely relative to hub and wheel if required.

### SUMMARY

It is an aspect of the present disclosure to provide a utility vehicle having an improved double-axle unit by means of which the disadvantages of conventional double-axle units can be avoided. In particular, it is the aspect of the present disclosure to provide a double-axle unit with two driven axles, by means of which efficiency advantages can be realized.

Said aspects are achieved by way of a utility vehicle having the features of the independent claim. Advantageous embodiments and uses of the present disclosure are the subject of the dependent claims and will be discussed in more detail, in part with reference to the figures, in the following description.

According to general aspects of the present disclosure, a utility vehicle having at least one double-axle unit is provided. The double-axle unit has a driven first axle and a driven second axle. Here, the first axle is driven in the conventional manner by the drivetrain of the utility vehicle, wherein, for example, the first axle is coupled in terms of movement to a drive shaft which is arranged between the internal combustion engine/gearbox unit and the first axle. A special feature of the double-axle unit according to the present disclosure lies in the fact that the second driven axle is driven by an auxiliary drive which is activatable and deactivatable and controllable independently of the main drive of the utility vehicle which drives the first axle.

A particular advantage of the present disclosure thus lies in the fact that no drive-through or articulated shaft is provided from the first axle to the second axle of the double-axle unit. The cumbersome drive-through axle can thus be dispensed with. Furthermore, efficiency advantages can be achieved because the auxiliary drive can be activated only in operating phases in which it is actually required, for example during starting on loose, muddy or icy underlying surfaces.

In a particular embodiment, the auxiliary drive is a hydrostatic auxiliary drive, such that the second axle can be driven by at least one hydraulic motor of a hydrostatic drive. By way of a hydrostatic auxiliary drive, it is possible to realize high torques with a comparatively low weight of the components required for the hydrostatic drive.

In the case of a double-axle unit of a utility vehicle, by contrast to a trailing or leading axle, both axles are designed for equal payloads. Furthermore, the two axles have similar tire configurations, that is to say the wheels of the two axles are either all of double-tire or all of single-tire configuration. The wheels of the axles of the double-axle unit are non-steerable. The spacing between the two axles in the direction of travel of the utility vehicle is generally less than two metres. Since the second axle is hydrostatically driven and is not connected by way of a drive-through to the first axle, the second axle may be designed as a lifting axle. In this case, the second axle preferably has an air suspension arrangement.

The utility vehicle is in particular a utility vehicle with an admissible maximum speed of over 60 km/h, and/or a utility vehicle which has a wheel brake device which acts on at least two wheels of the utility vehicle. The utility vehicle is preferably a motor truck or a motor bus.

The terms “first axle” and “second axle” serve merely for distinguishing between the two axles of the double-axle unit. In an embodiment, the first axle is the front axle of the double-axle unit in relation to a forward direction of travel of the vehicle, and the second axle is the rear axle of the double-axle unit in relation to the direction of travel. In an alternative embodiment, the first axle is the rear axle of the double-axle unit in relation to a forward direction of travel of the vehicle, and the second axle is the front axle of the double-axle unit in relation to the direction of travel.

The hydrostatic drive may, in a manner known per se, comprise a hydraulic pump, which is driven by a drive engine, in particular internal combustion engine, and the at least one hydraulic motor, which is connected to the hydraulic pump by way of hydraulic working lines and which is provided for the drive of the second axle of the double-axle unit. Both the hydraulic pump and the hydraulic motor may be designed as hydrostatic radial piston machines. An embodiment of the hydraulic pump or hydraulic motor as an axial piston unit is also possible. In particular, both the hydraulic pump and hydraulic motor may be designed as radial piston machines of similar type of construction.

The axles of the double-axle unit may, in a known manner, be designed as hypoid or external planetary axles.

Below, different embodiments of the present disclosure will be described as regards the arrangement of the hydraulic motor on the second axle.

In an embodiment, the hydraulic motor may be flange-mounted onto the outside of the axle housing of the second axle, wherein a drive shaft of the hydraulic motor is operatively connected to an axle differential, arranged in the axle housing, of the second axle. Instead of the axle differential of the second axle being driven by the drive-through of the first axle, as is the case in conventional double-axle units with two driven axles, it is the case in this embodiment that the axle differential is driven by a shaft which is driven by a hydraulic motor. This embodiment offers the advantage that no modifications, or only minor modifications, to the internal construction of the axle body of the second axle are required in order for said second axle to be driven hydrostatically rather than by way of the drive-through of the first axle.

A variant of this embodiment provides that the axle differential is a bevel-gear differential gearbox, having a crown gear, a pair of axle bevel gears and a pair of differential bevel gears, wherein the axle bevel gears mesh with the differential bevel gears and wherein a drive gear, for example a drive bevel gear, seated on a drive shaft of the hydraulic motor is in engagement with the crown gear of the axle differential.

In a further embodiment, it may be provided that the hydraulic motor is arranged in the axle housing of the second axle or is integrated into the axle housing. The hydraulic motor is thus arranged not on the outside of the axle housing but within the axle housing. In this embodiment, a part, which is rotatable coaxially with respect to the second axle, of the hydraulic motor is operatively connected to a cage of an axle differential of the second axle. The hydraulic motor thus drives the cage of the axle differential directly, and not indirectly via a crown gear. It is thus advantageously possible to dispense with a crown gear and with a drive bevel gear, which meshes with the crown gear, for the drive of the cage of the axle differential. The hydraulic motor can be seated on the shaft of the axle differential. A further advantage of this embodiment is the small amount of structural space that is taken up, because, outside the axle housing of the second axle, no structural space is required for the arrangement of the hydraulic motor.

A variant of this embodiment provides that, in the cage, there is mounted an axle bolt which bears differential gears, wherein said differential gears mesh with axle shaft gears arranged on wheel drive shafts, and said gears are in the form of bevel gears. In this variant, the hydraulic motor is designed as a radial piston motor known per se having an outer, static cam ring and having an inner, rotating cylinder housing which is connected rotationally conjointly to the cage, in order to rotate the latter and thereby drive the second axle.

In a further embodiment, two hydraulic motors are provided for the drive of the second axle, which hydraulic motors are integrated into the axle housing. In this embodiment, the second axle has two wheel drive shafts which are arranged coaxially, or in alignment with one another, and which, in each case, are connected rotationally conjointly at a wheel side to a wheel and, at the other end, are operatively connected to one of the two hydraulic motors. This variant offers the advantage that an axle differential can be dispensed with because the two wheel drive shafts are no longer coupled to one another in terms of movement. The wheel rotational speeds of the two wheels of the second axle can be adapted by way of correspondingly different actuation of the two hydraulic motors. The two wheel drive shafts are preferably splined shafts.

A variant of this embodiment provides that the two hydraulic motors are arranged in a central region or in the centre of the axle housing of the second axle. This offers the advantage that the structural space that is freed up as a result of the omission of the axle differential can be utilized for the arrangement of the hydraulic motors.

In a further variant, the two hydraulic motors may be arranged in each case on different wheel-side end regions of the axle housing of the second axle. The hydraulic motors are thus arranged at the outside in the axle. This offers the advantage that no long, elastic splined shafts are required. The hydraulic motors can transmit their drive power to the wheels with or without an external planetary gear set. An external planetary gear set between hydraulic motor and wheel hub offers the advantage that a higher torque can be generated. The two hydraulic motors may be arranged inwardly offset with respect to the respective wheel hub in an axial direction. The two hydraulic motors may however also be designed as wheel hub motors, that is to say may be positioned directly on the wheel hub.

Aside from the exemplary design, discussed above, of the auxiliary drive according to the present disclosure as a hydrostatic drive, said auxiliary drive may also be designed as an electric drive, such that the second driven axle is driven by at least one electric motor instead of the at least one hydraulic motor. With this alternative design of the auxiliary drive, too, the abovementioned embodiments and variants can be implemented, wherein, in each case, the one or more hydraulic motors must be replaced with an electric motor. Instead of a hydraulic pump and the fluid lines of the hydrostatic drive, it is correspondingly necessary to provide an electrical energy store, and/or an electrical generator that is driven by the drivetrain, and electrical lines.

Further details and advantages of the present disclosure will be described below with reference to the appended drawings, in which:

### BRIEF DESCRIPTION OF THE DRAWINGS

FIG. 1 shows a schematic plan view of a conventional double-axle unit;

FIG. 2 is a schematic illustration of a drive system for a motor vehicle according to the prior art with hydraulically driven wheel motors; and

FIGS. 3 to 6 are schematic illustrations of a hydraulically driven axle of a double-axle unit according to various embodiments of the present disclosure.

Identical or functionally equivalent elements are denoted by the same reference designations throughout the figures.

### DETAILED DESCRIPTION

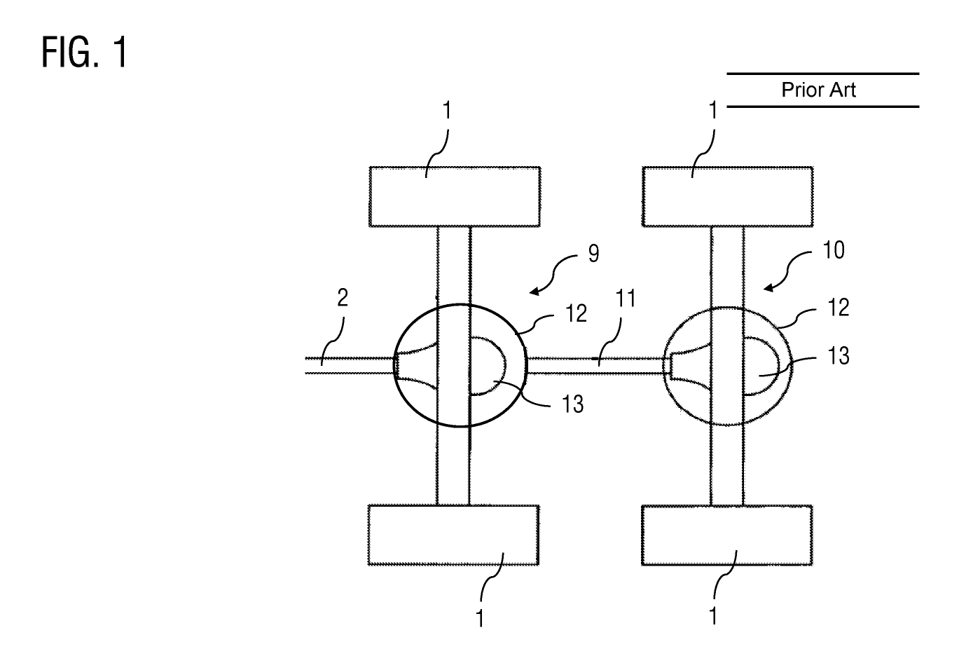

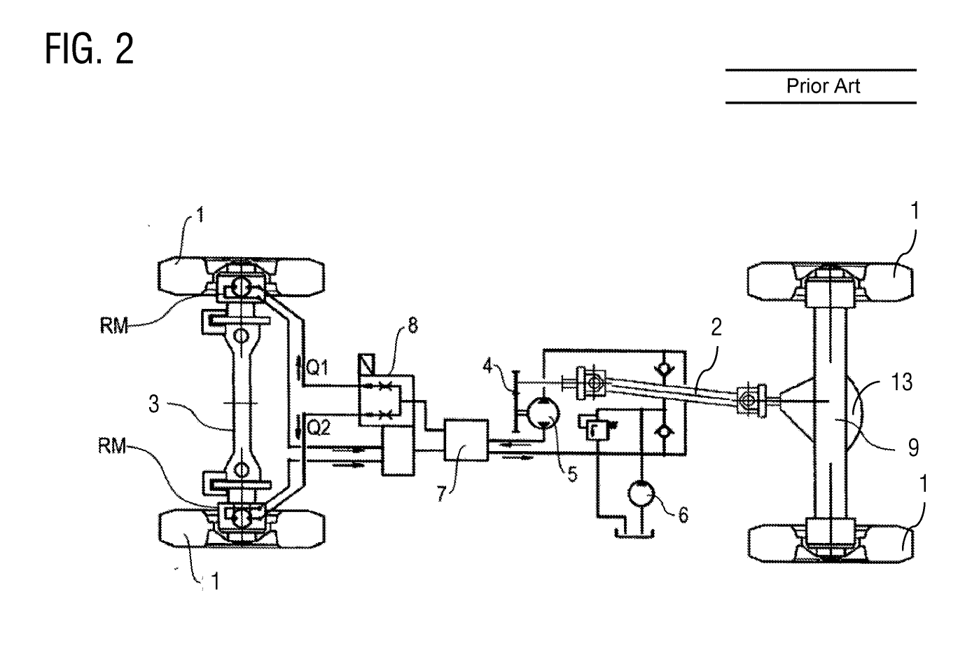

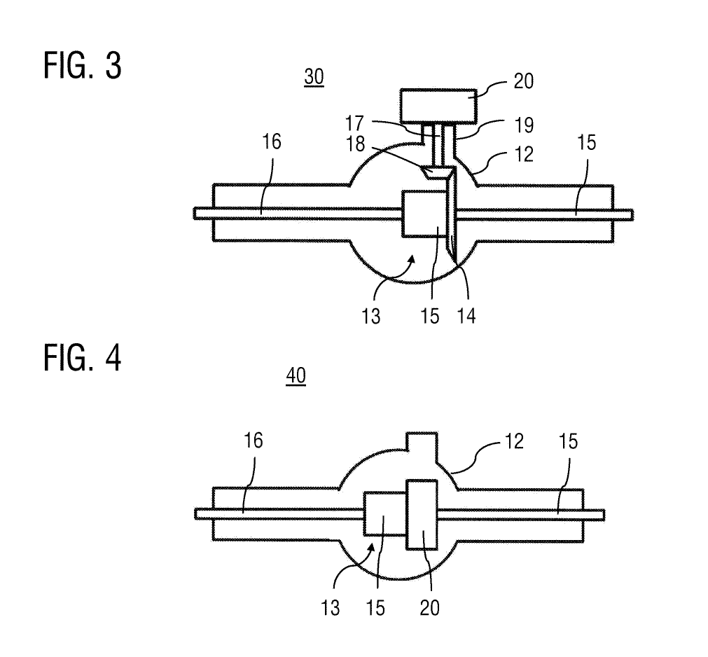

The aspects, shown in the figures, of the embodiments which, in FIGS. 1 and 2, relate to the prior art and, in FIGS. 3 to 6, relate to the present disclosure partially correspond, wherein similar or identical parts are denoted by the same reference designations and, for the explanation thereof, reference will also be made to the description of one or more other embodiments in order to avoid repetitions.

FIG. 3 shows a cross-sectional, highly schematic diagrammatic illustration of one of the two driven axles 30 of a double-axle unit of a utility vehicle. In the present case, the axle 30 constitutes the rear axle of the double-axle unit as viewed in a forward direction of travel. The front axle (not shown) is designed in a manner known per se and is driven by way of a mechanical drivetrain of the utility vehicle, as shown for example in FIG. 1.

The equalization of axle load between the two driven axles may be realized either by way of a pivotable central bearing, that is to say the axles are connected to one another by way of a rocker or are pivotable relative to one another by way of a central bearing. These embodiments are known as so-called leaf-spring-mounted double-axle units. Alternatively, the double-axle unit may be designed as an air-spring-mounted double-axle unit.

In a manner known per se, the second axle 30 has two wheel drive shafts 15, 16, and an axle differential 13 which is arranged in between and which is in the form of a conventional bevel-gear differential gearbox, of which FIG. 3 shows only the drive gear, in the form of a crown gear 14, and the cage 15. In the cage 15 there is mounted an axle bolt which bears differential gears, wherein the differential gears mesh with axle shaft gears arranged on the wheel drive shafts (in each case not illustrated). The differential or axle shaft gears are in each case in the form of bevel gears. The vehicle wheels that are driven by the wheel drive shafts are likewise not illustrated. Furthermore, in order to place the emphasis on the hydrostatic drive according to the present disclosure, further components and parts that are arranged in the axle housing, such as for example brackets, oil sump, baffle plates etc., which may be designed in the conventional manner, are not illustrated in FIG. 3 or in the following figures.

By contrast to the embodiment of the double-axle unit that is shown in FIG. 1 and known from the prior art, no drive-through from the first axle to the second axle 30 for the purposes of driving the crown gear 14 and thus the second axle 30 is provided.

Instead, the second driven axle 30 is driven by a hydraulic motor 20 of a hydrostatic drive. The hydraulic motor 20 is flange-mounted on the outside of the axle housing 12 of the second axle 30 at a flange region 19. A drive shaft 17 that is driven by the hydraulic motor has, on its distal end, a drive bevel gear 18 which meshes with the crown gear 14 of the axle differential 13, arranged in the axle housing 12, of the second axle 30. The hydraulic motor 20 is integrated into a closed hydrostatic circuit such as is known per se, for example analogously to the example shown in FIG. 2, wherein a hydraulic pump is mechanically driven by way of the drivetrain 4 of the vehicle and is hydraulically connected to the hydraulic motor 20 by way of fluid lines.

The prior art has disclosed various ways in which the hydraulic pump, for example a fixed displacement hydraulic pump, can be driven by way of the mechanical drivetrain. For example, the hydraulic pump may be driven by wheels and connected to the wheels of a mechanically driven axle via a fixed mechanical transmission ratio. A clutch, for example a multiplate powershift clutch, is provided between said axle and the fixed displacement hydraulic pump. In a further variant, it is for example possible for the internal combustion engine of the vehicle (or a crankshaft of the internal combustion engine) to be connected with driving action by way of a clutch to an input shaft of a power-splitting epicyclic gearbox. The epicyclic gearbox, for example in the form of a planetary gearbox, branches the power input via the input shaft into a hydrostatic power branch and a mechanical power branch. In particular, a first output shaft of the epicyclic gearbox directly drives a differential gearbox of the first axle of the double-axle unit and thereby forms the mechanical power branch. A second output shaft of the epicyclic gearbox drives, via a gearwheel stage, a hydraulic pump, and thus forms the hydrostatic power branch. The hydraulic pump in turn drives the one or more hydraulic motors 20 via hydraulic lines. The hydraulic motor 20 can be activated and deactivated by way of a control valve. Furthermore, a feed pump may be arranged so as to compensate internal and external leakage quantities that arise. In general, external leakage quantities are to be understood to mean quantities which are not evident to the naked eye. Hydraulic motor 20 and the hydraulic pump are in each case in the form of hydrostatic radial piston machines.

FIGS. 4 to 6 illustrate further possible embodiments of the present disclosure. Here, components with identical reference designations correspond to the components of FIG. 3, and will not be described separately. Below, only the differences and special features of the embodiments will be emphasized.

A special feature of the embodiment shown in FIG. 4 lies in the fact that the hydraulic motor 20 is not flange-mounted on the outside of the axle housing 12 but is arranged in the interior of the axle housing 12 of the second axle 40. Here, the hydraulic motor 20 replaces the crown gear 14 and, instead, directly drives the cage 15 of the axle differential 13. The hydraulic motor 20 is a radial piston motor having an outer, static cam ring and an inner, rotating cylinder housing which is connected rotationally conjointly to the cage 15 and which can thus set the latter in rotational motion. In turn, an axle bolt which bears differential gears is mounted in the cage 15, wherein said differential gears mesh with axle shaft gears which are arranged on wheel drive shafts and which are each in the form of bevel gears. The drive shaft 17 and the drive bevel gear 18 are therefore likewise not required in the embodiment of FIG. 4.

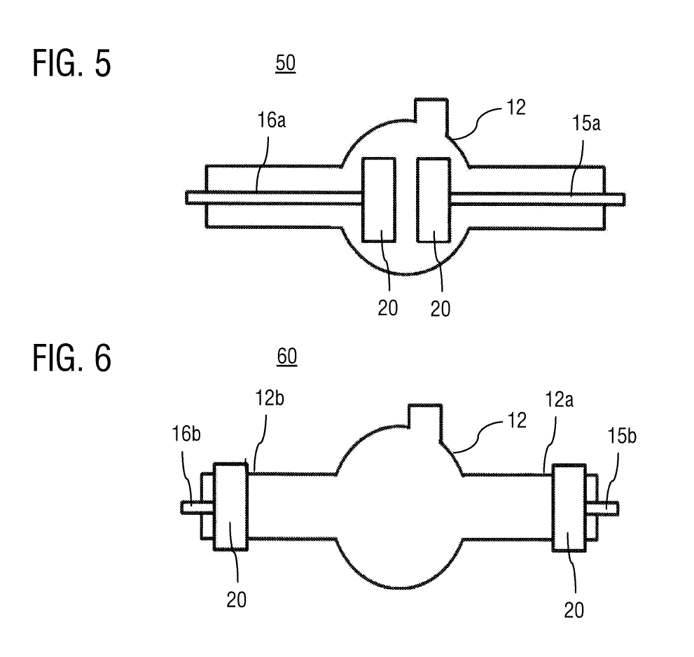

A special feature of the embodiment shown in FIG. 5 lies in the fact that two hydraulic motors 20 are mounted in the centre of the axle housing 12 of the second axle 50. The two wheel drive shafts 15a, 16a are in the form of splined shafts and are connected rotationally conjointly at a wheel side to a wheel and, at the other end, are operatively connected to one of the two hydraulic motors 20. The axle differential is omitted. Each of the wheel drive shafts 15a, 16a is thus driven by one of the two hydraulic motors 20. The operative connection between hydraulic motor 20 and the wheel drive shaft may optionally also be realized via an external planetary gear set in order to realize an increase in torque.

A special feature of the embodiment shown in FIG. 6 lies in the fact that the two hydraulic motors 20 are arranged in each case on different wheel-side end regions 12a, 12b of the axle housing 12 of the second axle 60. The wheel drive shafts 15b, 16b are again in the form of splined shafts, but are now of correspondingly shorter form. In this embodiment, too, an axle differential is no longer required, because the hydraulic motors 20 can drive the two wheel drive shafts 15b, 16b in each case independently of one another.

The hydraulic motors 20 may transmit their drive power to the wheels optionally with or without an external planetary gear set. The two hydraulic motors may be arranged inwardly offset with respect to the respective wheel hub in an axial direction. The two hydraulic motors may however also be designed as wheel hub motors, that is to say may be positioned directly on the wheel hub, analogously to the example described in FIG. 2 and in document EP 1 886 861 A2.

Even though the present disclosure has been described with reference to particular exemplary embodiments, it is evident to a person skilled in the art that various changes may be made, and equivalents used as substitutes, without departing from the scope of the present disclosure. Furthermore, numerous modifications may be made without departing from the associated scope. Consequently, the present disclosure is not intended to be restricted to the exemplary embodiments disclosed, but rather is intended to encompass all exemplary embodiments which fall within the scope of the appended patent claims. In particular, the present disclosure also claims protection for the subject matter and the features of the subclaims independently of the claims referred back to.

### LIST OF REFERENCE DESIGNATIONS

1 Wheel
2 Drive shaft
3 Front axle
4 Drivetrain
5 Main pump
6 Feed pump
7 Control valve
8 Pressurized-oil distributor
9 Front axle of the double-axle unit
10 Rear axle of the double-axle unit
11 Drive-through
12 Axle housing
13 Axle differential, e.g. bevel-gear differential gearbox
14 Drive gear of the axle differential, e.g. crown gear
15 Cage
15, 15a, 15b, 16, 16a, 16b Wheel drive shaft
17 Drive shaft
18 Drive bevel gear
19 Flange region
20 Hydraulic motor
30, 40, 50, 60 Second, hydrostatically driven axle of the double-axle unit
RM Hydraulic wheel-hub motors

1. A utility vehicle comprising:
at least one double-axle unit having a first driven axle and a second driven axle, wherein the first driven axle is driven by way of a mechanical drivetrain and the second driven axle is driven by at least one hydraulic motor of a hydrostatic drive.

2. The utility vehicle according to claim 1, wherein the hydrostatic drive further comprises a hydraulic pump driven by a drive engine and the at least one hydraulic motor which is connected to the hydraulic pump by way of hydraulic working lines.

3. The utility vehicle according to claim 1, wherein the first axle is the front axle of the double-axle unit in relation to a forward direction of travel of the vehicle, and the second axle is the rear axle of the double-axle unit in relation to the direction of travel.

4. The utility vehicle according to claim 1, wherein the hydraulic motor is flange-mounted onto the outside of the axle housing of the second drive axle, and a drive shaft of the hydraulic motor is operatively connected to an axle differential, arranged in the axle housing, of the second driven axle.

5. The utility vehicle according to claim 4, wherein the axle differential is a bevel-gear differential gearbox, including a crown gear, a pair of axle bevel gears and a pair of differential bevel gears, and wherein a drive gear seated on the drive shaft of the hydraulic motor is in engagement with the crown gear.

6. The utility vehicle according to claim 1, wherein the hydraulic motor is arranged in the axle housing of the second driven axle, and a part, which is rotatable coaxially with respect to the second axle, of the hydraulic motor is operatively connected to a cage of an axle differential of the second driven axle.

7. The utility vehicle according to claim 6, wherein in the cage, there is mounted an axle bolt which bears differential gears, wherein said differential gears mesh with axle shaft gears arranged on wheel drive shafts, and said gears are in the form of bevel gears; and

8. The utility vehicle according to claim 6, wherein the hydraulic motor is a radial piston motor having an outer, static cam ring and having an inner, rotating cylinder housing which is connected rotationally conjointly to the cage.

9. The utility vehicle according to claim 1, further comprising two hydraulic motors, wherein the second driven axle has two wheel drive shafts which are arranged coaxially and which, are connected rotationally conjointly at a wheel side to a wheel and, at the other end, are operatively connected to one of the two hydraulic motors.

10. The utility vehicle according to claim 9, wherein the two hydraulic motors are arranged in a central region of the axle housing of the second axle.

11. The utility vehicle according to claim 9, wherein the two hydraulic motors are arranged on different wheel-side end regions of the axle housing of the second axle.

12. The utility vehicle according to claim 11, wherein the two hydraulic motors are designed as wheel hub motors.

13. The utility vehicle according to claim 11, wherein the two hydraulic motors are arranged offset with respect to the respective wheel hub in an axial direction and are operatively connected to the wheels by way of an external planetary gear set.

14. The utility vehicle according to claim 1, wherein instead of a hydrostatic drive for the second axle, an electric drive is provided, such that the second driven axle is driven by at least one electric motor.

15. The utility vehicle according to claim 1, wherein the first or second axle of the double-axle unit is case designed for equal payloads.

16. The utility vehicle according to claim 1, wherein the first or second axle of the double-axle unit have similar tire configurations.

17. The utility vehicle according to claim 1, wherein the first or second axle of the double-axle unit have a spacing of less than 2 metres in the direction of travel of the utility vehicle.

18. The utility vehicle according to claim 1, wherein the first or second axle of the double-axle unit is designed as hypoid or external planetary axles.

19. The utility vehicle according to claim 1 comprising an admissible maximum speed of over 60 km/h.

20. The utility vehicle according to claim 1 comprising a wheel brake device which acts on at least two wheels of the utility vehicle.
